(19) United States
(12) Patent Application Publication
(10) Pub. No.: US 2013/0119797 A1
(43) Pub. Date: May 16, 2013

(54) SPINDLE MOTOR

(71) Applicants: Yun Yeong Park, Gyunggi-do (KR); Yeol Choi, Gyunggi-do (KR); Ho Jun Yoo, Gyunggi-do (KR)

(72) Inventors: Yun Yeong Park, Gyunggi-do (KR); Yeol Choi, Gyunggi-do (KR); Ho Jun Yoo, Gyunggi-do (KR)

(73) Assignee: SAMSUNG ELECTRO-MECHANICS CO., LTD., Gyunggi-do (KR)

(21) Appl. No.: 13/614,221

(22) Filed: Sep. 13, 2012

(30) Foreign Application Priority Data
Nov. 10, 2011 (KR) 10-2011-0117158

(51) Int. Cl. H02K 7/00

(52) U.S. Cl. 310/66

(57) ABSTRACT

Disclosed herein is a spindle motor in which a space part is formed between a shaft and a rotor case and a hooker part and a fixing part coupled to each other are formed at a bearing holder and a rotor case, respectively, thereby making it possible to easily prevent floating of a rotor without using a separate component.

### CROSS REFERENCE TO RELATED APPLICATION

This application claims the benefit of Korean Patent Application No. 10-2011-0117158, filed on Nov. 10, 2011, entitled “Spindle Motor”, which is hereby incorporated by reference in its entirety into this application.

### BACKGROUND OF THE INVENTION

1. Technical Field

The present invention relates to a spindle motor.

2. Description of the Related Art

In a spindle motor, a shaft rotates while maintaining a predetermined contact section between the shaft and a bearing, such that rotational characteristics may be easily maintained Therefore, the spindle motor has been widely used as a driving unit of a recording medium requiring high speed rotation, such as a hard disk drive (HDD), an optical disk drive (ODD), or the like.

The spindle motor generally includes an armature, a rotor including a magnet generating electromagnetic force between the magnet and the armature, and a stator rotatably supporting the rotor, and rotates the rotator by the electromagnetic force generated between the armature and the magnet to easily drive the recording medium.

Meanwhile, the spindle motor requires the high speed rotation as described above. Due to this feature, the spindle motor has a problem that the rotor floats. In order to solve this problem, the spindle motor is designed so as to use a floating preventing structure. In the case of a general slim type spindle motor, the floating of the rotor has been prevented through a stopper structure.

This has been disclosed in detail in Patent Document 1. In Patent Document 1, a depressed hooked part having a ring shape is formed at a lower end of a shaft having a rotor installed at an upper portion thereof and a stopper is installed in a bearing holder in which the shaft is rotatably installed to allow the hooked part to be hooked by the stopper, thereby preventing the floating of the rotor.

Meanwhile, in a spindle motor used in ultra and slot-in models, the floating of the rotor has been prevented through a hooker structure. This has been disclosed in detail in Patent Document 2. In Patent Document 2, a hooked rim is formed at an upper end of a bearing holder and a stopper corresponding to the hooked rim is formed at a lower portion of a rotor, such that the stopper is hooked by the hooked rim, thereby preventing the floating of the rotor.

In a floating preventing structure disclosed in the prior art including Patent Document 1 and Patent Document 2, a separate component such as a stopper is used in order to prevent the floating of the rotor, such that a manufacturing cost increases.

In addition, the floating preventing structure according to the prior art requires separate assembling manpower for installing the stopper in the spindle motor, or the like, such that the entire workability is deteriorated.

### PRIOR ART DOCUMENT

### Patent Document

(Patent Document 1) KR2011-0075712 A

(Patent Document 2) KR2008-0054836 A

### SUMMARY OF THE INVENTION

The present invention has been made in an effort to provide a spindle motor capable of easily preventing floating of a rotor without an increase in a manufacturing cost due to the prevention of the floating of the rotor and deterioration of workability due to an increase in assembling manpower, or the like.

According to a preferred embodiment of the present invention, there is provided a spindle motor including: a rotor including a rotor case installed at an upper portion of a shaft; a stator including a bearing holder having a bearing embedded therein in order to support the shaft; an armature including a core provided on the bearing holder; a space part formed between the shaft and the rotor case so as to receive an upper end portion of the bearing holder therein; and a hooker part and a fixing part formed at the upper end portion and the rotor case, respectively, and coupled to each other on the space part.

The space part may be formed by interposing a guide member between the shaft and the rotor case.

The hooker part may protrude from a side of the upper end portion and the fixing part may be formed in a groove shape in the rotor case so as to receive the hooker part therein.

The spindle motor may further include a pulling magnet provided at the rotor case.

The pulling magnet may be provided on a lower surface of the rotor case so as to face the armature.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a cross-sectional view showing a spindle motor according to a preferred embodiment of the present invention;

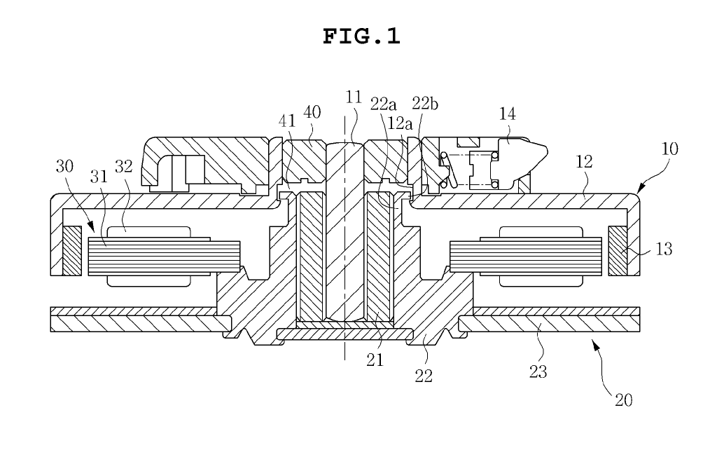

FIG. 2 is an enlarged cross-sectional view showing main components of FIG. 1; and

FIG. 3 is a cross-sectional view showing an example in which a pulling magnet is included in the spindle motor according to the preferred embodiment of the present invention.

### DESCRIPTION OF THE PREFERRED EMBODIMENTS

The objects, features and advantages of the present invention will be more clearly understood from the following detailed description of the preferred embodiments taken in conjunction with the accompanying drawings. Throughout the accompanying drawings, the same reference numerals are used to designate the same or similar components, and redundant descriptions thereof are omitted. Further, in the following description, the terms “first”, “second”, “one side”, “the other side” and the like are used to differentiate a certain component from other components, but the configuration of such components should not be construed to be limited by the terms. Further, in the description of the present invention, when it is determined that the detailed description of the related art would obscure the gist of the present invention, the description thereof will be omitted.

Hereinafter, preferred embodiments of the present invention will be described in detail with reference to the attached drawings.

A spindle motor according to a preferred embodiment of the present invention includes a rotor including a rotor case installed at an upper portion of a shaft, a stator 20 including a bearing holder having a bearing embedded therein in order to support the shaft 11, an armature 30 including a core provided on the bearing holder 22.

In addition, the spindle motor includes a space part 41 formed between the shaft 11 and the rotor case 12 to receive an upper end portion 22a of the bearing holder 22 therein and a hooker part 22b and a fixing part 12a formed at the upper end portion 22a and the rotor case 12, respectively, and coupled to each other on the space part 41.

The shaft 11 serves as a center axis of the rotor at the time of rotation of the rotor 10 through electromagnetic force generated between the armature 30 and the rotor 10. Therefore, the shaft 11 is positioned at the center of the rotor 10 and is also positioned at the center of the entire spindle motor.

To this end, the shaft 11 is inserted into the bearing 21 corresponding to the center of the spindle motor. Therefore, the bearing 21 supports the shaft 11 inserted thereinto to allow the rotor 10 installed at the upper portion of the shaft to stably rotate.

The shaft 11 is installed with the rotor case 12, as described above. The rotor case 12, which is a kind of disk plate, includes a magnet disposed therein in order to generate electromagnetic force between the magnet and the armature 30 to rotate the rotor and includes a clamp 14 disposed thereon in order to elastically fix a recording medium, that is, a magnetic disk or an optical disk.

Therefore, the rotor 20 rotates by the electromagnetic force generated between the magnet 13 and the armature 30 to rotate the recording medium elastically fixed to the clamp 14, thereby making it possible to write or reproduce data.

The rotor case 12 is generally installed in a scheme in which it is press-fitted into the upper portion of the shaft 11. In the spindle motor according to the preferred embodiment of the present invention, the rotor case 12 is installed in a scheme in which a guide member 40 is interposed between the rotor case 12 and the shaft.

That is, the guide member 40 is press-fitted and installed on an outer surface of the upper portion of the shaft 11 and the rotor case 12 is also press-fitted and installed on an outer surface of the guide member 40, such that the space part 41, which is a kind of empty space, is formed between the rotor case 12 and the shaft 11.

Meanwhile, in the stator 20 according to the preferred embodiment of the present invention, the bearing holder 22 is installed on a base plate 23 and has the bearing 21 embedded therein in order to support the shaft 11.

In this configuration, an upper portion of the bearing holder 22 is provided with the upper end portion 22a received in the space part 41 described above, wherein the upper end portion 22a is formed in a scheme of extending the entire upper portion of the bearing holder 22 in an upward direction or in a scheme of extending a portion of the upper portion of the bearing holder 22 contacting the bearing 21 in the upward direction.

According to the preferred embodiment of the present invention, the upper end portion 22a is formed in the scheme of extending a portion of the upper portion of the bearing holder 22 contacting the bearing 21 in the upward direction.

In addition, the bearing 21 embedded in the bearing holder 22 is extended so as to be positioned up to a height of the upper end portion 22a of the bearing holder 22, thereby making it possible to additionally provide an effect that a support portion 21a supporting the shaft 11 is extended.

The support portion 21a is extended, such that the spindle motor according to the preferred embodiment of the present invention may use the bearing 21 having a length increased as compared to a generally used bearing by about 20%. Therefore, the shaft 11 may be stably supported without being shaken.

An outer portion of the bearing holder 22 having the bearing 21 embedded therein is provided with the core 31, such that the armature 30 is installed between the rotor 10 and the stator 20. Here, the core 31 has the coil wound therearound. Since the winding of the coil 32 is well known, a detailed description thereof will be omitted.

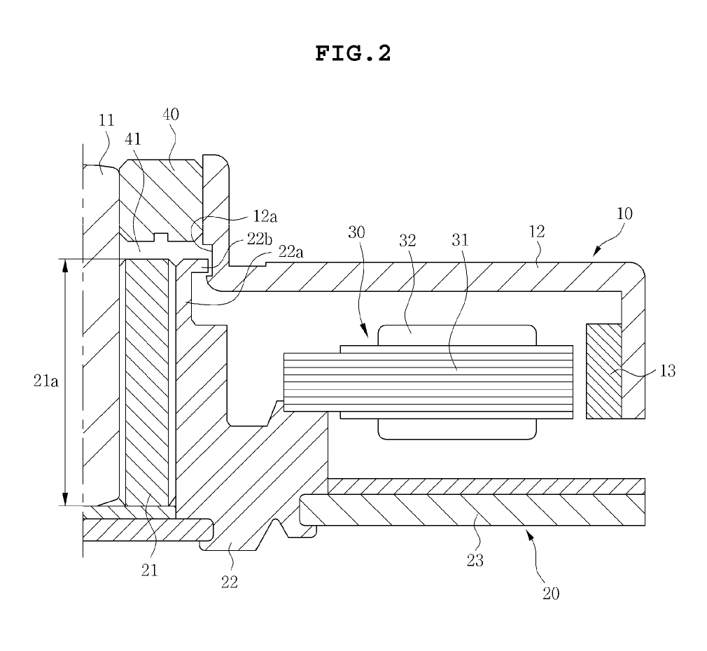

Meanwhile, the hooker part 22b and the fixing part 12b according to the preferred embodiment of the present invention are configured as follows. That is, as shown in FIG. 2, in the hooker part 22b and the fixing part 12b coupled to each other on the space part 41, the hooker part 22b protrudes from a side of the upper end portion 22a toward the fixing part 12a. In addition, the fixing part 12a is formed in a groove shape in the rotor case 12 facing the upper end portion 22a to receive the hooker part 22b therein.

Therefore, the hooker part 22b is positioned in the fixing part 12a at the usual time interferes with the fixing part 12a at the time of generation of floating in a rotation process of the rotor 10 to prevent the rotor 10 from being floated.

Since the hooker part 22b is formed integrally with the upper end portion 22a in a process of manufacturing of the base holder 22, it may be easily formed by injection molding, or the like, using a mold. In addition, the fixing part 12a may be easily formed in a scheme of manufacturing the rotor case 12 and processing one surface of the rotor case 12.

The spindle motor according to the preferred embodiment of the present invention preventing the floating of the rotor 10 through the hooker part 22b and the fixing part 12a may further include a pulling magnet. The pulling magnet 50 is provided at the rotor 10 to prevent the floating of the rotor 10 through magnetic force.

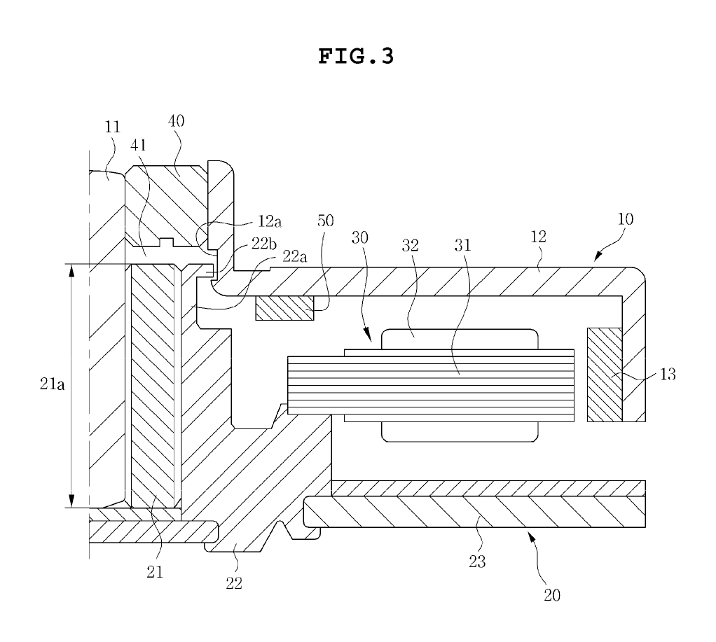

That is, as shown in FIG. 3, a lower portion of the rotor 10, more specifically, a lower surface of the rotor case 12 facing the armature 30 is provided with the pulling magnet 50, thereby preventing the floating of the rotor 10 through an interaction between the pulling magnet 50 and the armature 30.

As set forth above, according to the preferred embodiment of the present invention, the hooker part and the fixing part formed at the upper end portion of the bearing holder and the rotor case, respectively are coupled to each other on the space part formed between the shaft and the rotor case to receive the upper end portion of the bearing holder, thereby making it possible to easily prevent the floating of the rotor without using a separate component such as a stopper. Therefore, it is possible to reduce a manufacturing cost and improve workability.

Meanwhile, in addition to the hooker part and the fixing part, the pulling magnet is provided on the lower surface of the rotor case, thereby making it possible to more effectively prevent the floating of the rotor. Therefore, it is possible to stably maintain the rotating state of the spindle motor.

Although the embodiments of the present invention have been disclosed for illustrative purposes, it will be appreciated that the present invention is not limited thereto, and those skilled in the art will appreciate that various modifications, additions and substitutions are possible, without departing from the scope and spirit of the invention.

Accordingly, any and all modifications, variations or equivalent arrangements should be considered to be within the scope of the invention, and the detailed scope of the invention will be disclosed by the accompanying claims.

What is claimed is:

1. A spindle motor comprising:
a rotor including a rotor case installed at an upper portion of a shaft;
a stator including a bearing holder having a bearing embedded therein in order to support the shaft;
an armature including a core provided on the bearing holder;
a space part formed between the shaft and the rotor case so as to receive an upper end portion of the bearing holder therein; and
a hooker part and a fixing part formed at the upper end portion and the rotor case, respectively, and coupled to each other on the space part.

2. The spindle motor as set forth in claim 1, wherein the space part is formed by interposing a guide member between the shaft and the rotor case.

3. The spindle motor as set forth in claim 1, wherein the hooker part protrudes from a side of the upper end portion and the fixing part is formed in a groove shape in the rotor case so as to receive the hooker part therein.

4. The spindle motor as set forth in claim 3, further comprising a pulling magnet provided at the rotor case.

5. The spindle motor as set forth in claim 4, wherein the pulling magnet is provided on a lower surface of the rotor case so as to face the armature.
